(19) United States
(12) Patent Application Publication
(10) Pub. No.: US 2011/0056630 A1
(43) Pub. Date: Mar. 10, 2011

(54) SEGMENTED VERTICAL VANE COVERING FOR ARCHITECTURAL OPENINGS

(75) Inventor: Nickolas Christopher Buccola, JR., Thornton, CO (US)

(73) Assignee: Hunter Douglas Inc., Upper Saddle River, NJ (US)

(21) Appl. No.: 12/877,620

(22) Filed: Sep. 8, 2010

Related U.S. Application Data
(60) Provisional application No. 61/240,790, filed on Sep. 9, 2009.

(51) Int. Cl. E06B 9/36

(52) U.S. Cl. 160/168.1 V

(57) ABSTRACT

A vertical vane covering for architectural openings includes at least one set of stationary vanes and a second set of mobile vanes, with the mobile vanes being movable between extended and retracted positions as well as being pivotable between open and closed positions without disturbing the stationary vanes. The covering can be made in a center draw or a side draw, depending upon the configuration of a control system for operating the covering.

### CROSS REFERENCE TO RELATED APPLICATIONS

The present application claims the benefit under 35 U.S.C. §119(e) to U.S. Provisional Patent Application No. 61/240,790 (“the '790 application”), which was filed on Sep. 9, 2009, and entitled Segmented Vertical Vane Covering for Architectural Openings. The '790 application is incorporated by reference into the present application in its entirety.

### BACKGROUND OF THE INVENTION

1. Field of the Invention

The present invention relates generally to coverings for architectural openings such as doors, windows, archways, and the like, and more particularly to a vertical vane covering having stationary and mobile sets of vanes, which are suspended from a headrail by a control system. The control system is adapted to extend a lead edge of the mobile system horizontally across the architectural opening to move the covering and particularly the mobile set of vanes between extended and retracted positions while leaving the stationary set of vanes in an extended position. The mobile vanes can also be pivoted about vertical axes between open and closed positions with or without affecting pivoting of the stationary vanes according to optional set-ups of the covering.

2. Description of the Relevant Art

Coverings for architectural openings, such as doors, windows, archways, and the like, have been known in various forms for many years. One form of such covering is commonly referred to as a vertical vane covering wherein a control system suspends and is operable to selectively manipulate a plurality of vertically suspended vanes such that the vanes can be moved laterally across the architectural opening to extend or retract the covering and pivoted about longitudinal vertical axes to open and close the vanes.

Vertical vane coverings typically include a horizontal headrail on which the control system is mounted with the control system including a plurality of carriers associated with the vanes with the carriers being mounted for sliding movement along the length of the headrail. The carriers include internal mechanisms for pivoting the vanes suspended from the carriers about longitudinal vertical axes between open and closed positions. Control cords are included in the control system to move a lead carrier along the length of the headrail to extend and retract the covering. The carriers are interconnected with a linkage so that movement of the lead carrier effects a following movement of the remaining carriers.

The control system further includes a tilt rod which extends from one end of the headrail to the opposite end and is operatively and slidably connected to the carriers so that rotation of the tilt rod about its longitudinal horizontal axis effects pivotal movement of the vanes about their longitudinal vertical axes between the open and closed positions. The tilt rod itself is rotated with a separate control cord or wand disposed at one end of the headrail.

In such vertical vane coverings, all of the vanes are operatively interconnected for movement together through the interconnection of the carriers with the linkage. In some installations, however, and particularly where the covering extends a substantial distance past the lateral sides of an architectural opening, it might be desirable that not all of the vanes extend and retract or open and close with the other vanes, and where some of the vanes might maintain a fixed orientation.

It is to provide a vertical vane covering for architectural openings where not all of the vanes move together that the present invention has been developed.

### SUMMARY OF THE INVENTION

Pursuant to the present invention, a vertical vane covering for architectural openings includes a stationary set of vanes and a mobile set of vanes which are suspended by a control system from a headrail for the covering. The control system is operative to move the mobile vanes between extended and retracted positions of the covering without effecting a static extended position of the stationary vanes and also pivot the mobile vanes about longitudinal vertical axes between open and closed positions with or without pivoting of the stationary vanes depending upon an optional set-up of the covering.

The afore features of the present invention are accomplished with a control system that is common to the carriers for both the stationary set of vanes and the mobile set of vanes, but wherein the carriers for the stationary set of vanes may be rendered inoperative so that in an optional arrangement the mobile set of vanes can be moved with the control system between extended and retracted positions as well as open and closed positions independently of the stationary vanes. In an alternative arrangement, the stationary vanes remain extended at all times but will pivot between open and closed positions with the mobile vanes.

The control system may include two linkage systems in the headrail with one associated with the mobile vanes and the other the stationary vanes, and with the two linkages supporting carriers which suspend both the stationary and mobile vanes from the headrail in a uniformly spaced manner. The stationary vanes are always in an extended position so that when the set of mobile vanes is extended, there is no visible difference between the stationary and mobile vanes. The carriers associated with the stationary vanes may be rendered inoperative insofar as pivoting the vanes between open and closed positions, even though the control system extends therethrough, so that the control system is optionally operative in pivoting the mobile vanes and not the stationary vanes in operation of the covering.

As will be appreciated with the detailed description hereafter, when the mobile vanes are moved to their retracted position, the stationary vanes remain in an extended position. However, as mentioned above, when the mobile vanes are in their extended position, the stationary vanes are also extended so as to appear in uniformly spaced relationship with the mobile vanes.

While not being necessary, the stationary vanes might be mounted within a building structure so as to overlie a wall adjacent to an architectural opening while the mobile vanes overlie the architectural opening itself giving the sensation of a larger architectural opening.

Other aspects, features and details of the present invention can be more completely understood by reference to the following detailed description of a preferred embodiment, taken in conjunction with the drawings and from the appended claims.

### BRIEF DESCRIPTION OF THE DRAWINGS

FIG. 1 is an isometric of a vertical vane covering in accordance with the present invention in a fully extended position with the vanes being opened.

FIG. 2 is an isometric similar to FIG. 1 with the covering in a retracted position while the vanes are open.

FIG. 3 is a fragmentary isometric showing a portion of the headrail for the covering of FIG. 1 in conjunction with a pair of vane carriers and a spacer bar pursuant to the present invention.

FIG. 4 is an isometric looking downwardly on the spacer bar from one side.

FIG. 5 is an isometric similar to FIG. 4 looking downwardly on the spacer bar from the opposite side.

FIG. 6 is a top plan view of the spacer bar of FIG. 4.

FIG. 7 is a front elevation of the spacer bar as shown in FIG. 6.

FIG. 8 is a left end elevation of the spacer bar as shown in FIG. 7.

FIG. 9 is an enlarged fragmentary isometric similar to FIG. 1.

FIG. 10 is a top plan view of the covering as shown in FIG. 9.

FIG. 11 is a top plan view similar to FIG. 10 with the mobile set of vanes in a partially retracted position.

FIG. 12 is a fragmentary top plan similar to FIG. 11 with the mobile vanes fully retracted.

FIG. 13 is a fragmentary isometric of the covering as shown in FIG. 12.

FIG. 14 is a fragmentary top plan view similar to FIG. 11 wherein the covering is fully extended, but with the mobile vanes in a closed position, and the stationary vanes shown in dashed lines in an optional arrangement of the covering.

FIG. 15 is an enlarged section taken along line 15-15 of FIG. 11.

### DETAILED DESCRIPTION OF THE INVENTION

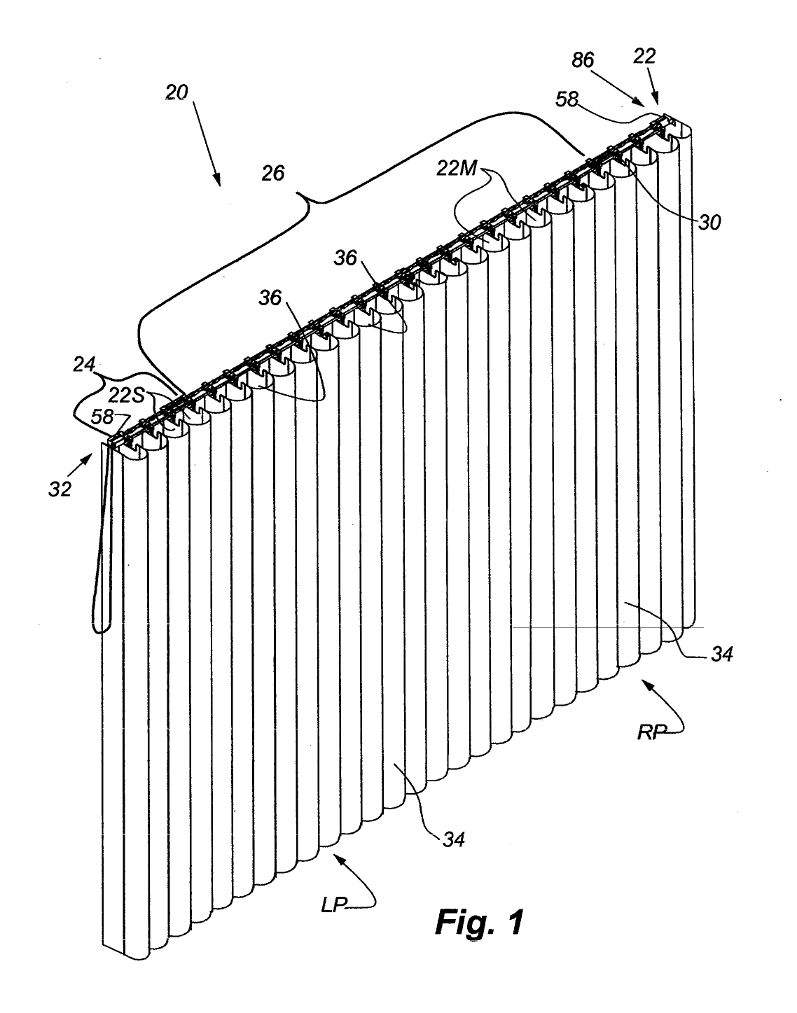

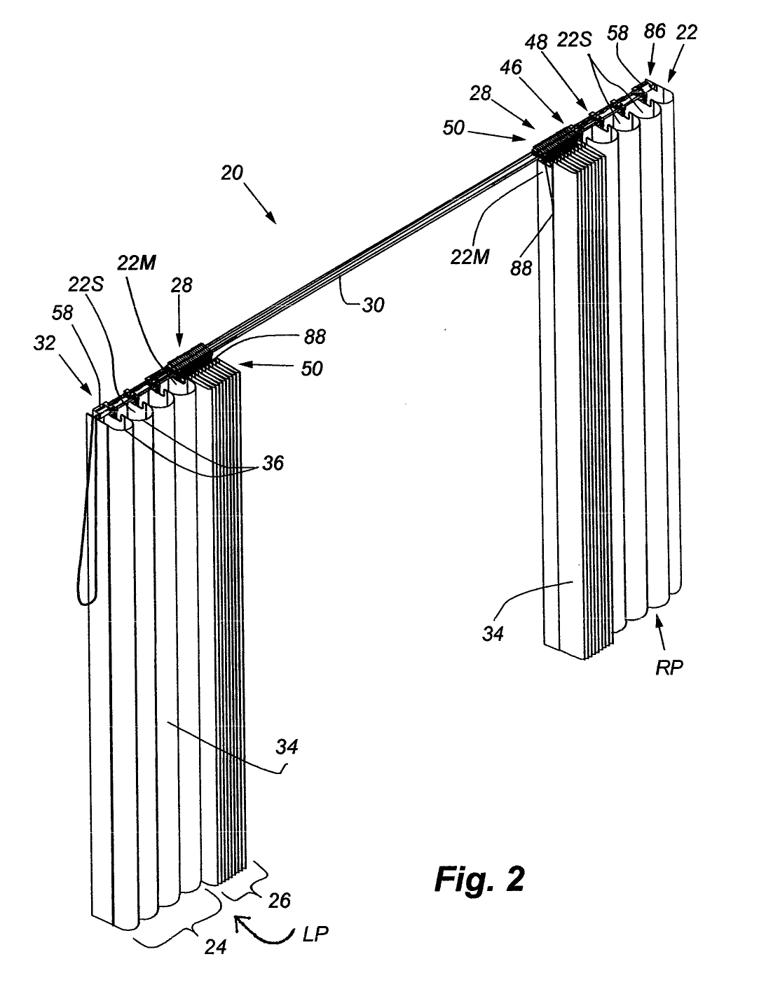

A covering 20 pursuant to the present invention can be seen generally in FIGS. 1 and 2 to include a plurality of vertically extending vanes 22, which are divided into a set 24 of stationary vanes 22S and a set 26 of mobile vanes 22M. The vanes are suspended from a control system 28 in a headrail 30 for the covering with the movable vanes being translatable along the length of the headrail between an extended position, as shown in FIG. 1, and a retracted position as shown in FIG. 2. As will be appreciated, the stationary vanes 22S remain in a static or fixed extended and open position regardless of the movement of the mobile vanes 22M, which are spaced from the one end 32 of the headrail by the set of stationary vanes.

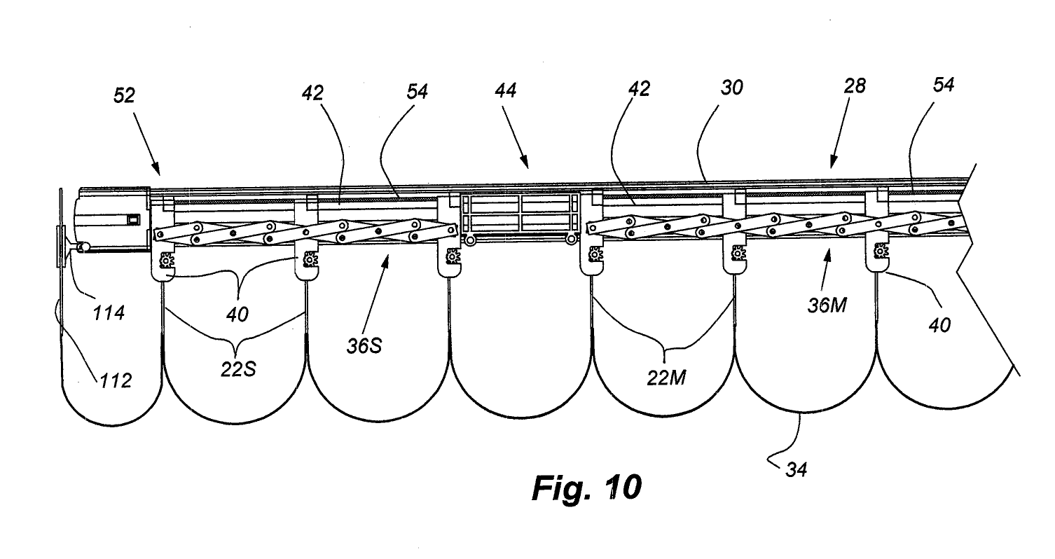

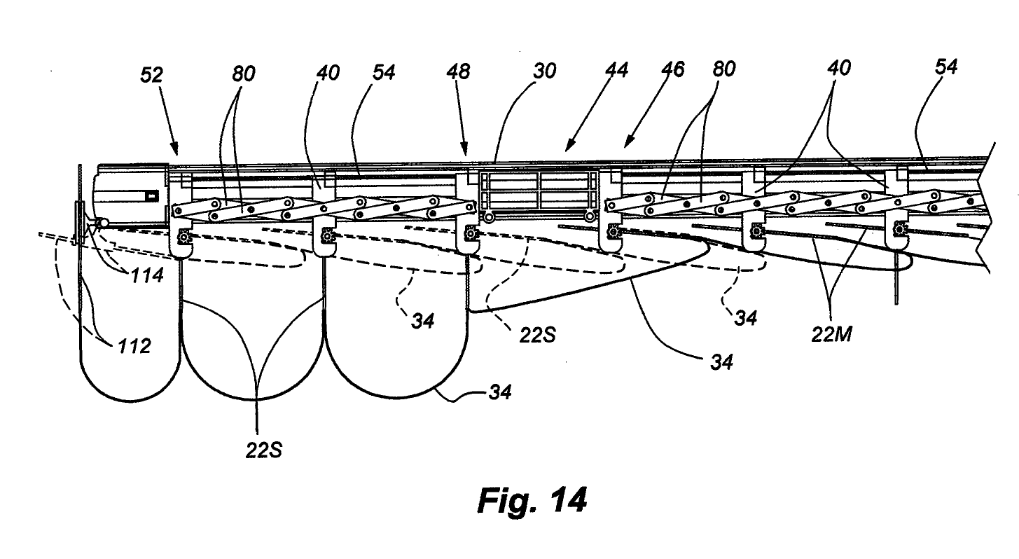

As will be appreciated with the description that follows, the mobile vanes 22M can also be pivoted about a vertical longitudinal axis of each vane with the control system 28 between an open position (FIG. 10), wherein the mobile vanes are parallel with the stationary vanes 22S in an open position, and a closed position (FIG. 14) wherein the mobile vanes are substantially parallel and overlapping with each other but perpendicular to open stationary vanes. The stationary vanes while being principally described as not being pivotable between open and closed positions can be pivoted in an optional arrangement as will be described later.

It should also be appreciated that while the present invention is shown in FIGS. 1 and 2 as being a covering having left LP and right RP panels commonly referred to as a center-draw covering, the principles of the invention would also be applicable to a covering that was a side draw (not shown). In a center draw, there are left LP and right RP panels mounted adjacent to respective associated sides of an architectural opening which extend in the extended position of the covering toward the center of the opening to a contiguous relationship at the center of the opening with the opposing panel. In a side-draw covering, a single panel is mounted along one side of the architectural opening and is extendable to the opposite side of the opening.

It will be further appreciated that in the disclosed embodiment of the invention, both the stationary 22S and mobile 22M vanes in a panel are interconnected with a sheet of flexible face sheet material 34 which forms a plurality of loops 36, which simulate a pleated curtain. The face sheet material is preferably a fabric material, such as sheer, and is connected at spaced locations to the front edge of each vane in the covering so that a loop of the face sheet material is formed between each vane. It should be understood, however, that the concepts of the present invention are applicable to other forms of vertical vane coverings, and the covering illustrated is for illustrative purposes only.

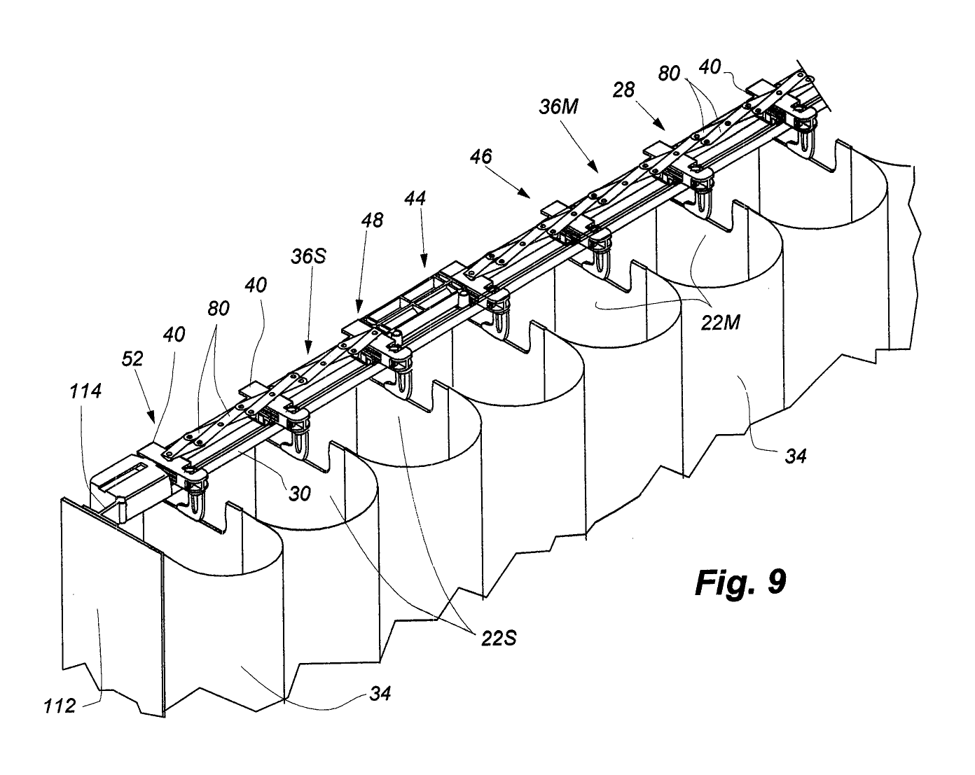

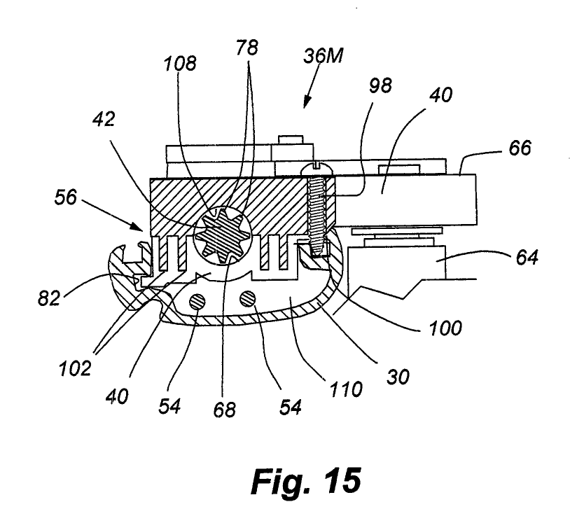

The preferred control system 28 (FIGS. 9-15) for the present invention includes a pair of linkage systems 38M and 38S, one interconnecting each mobile vane and the second interconnecting each stationary vane, respectively. The vanes 22M and 22S are in turn suspended from carriers 40 that are operatively connected to an associated linkage system with the carriers also being operatively associated with a tilt rod 42 (FIG. 15) that extends horizontally the length of the headrail and passes through each carrier so that the vanes connected to the carriers can be pivoted between open and closed positions, if desired, about their longitudinal vertical axes as will be described in more detail hereafter.

As will also be described in more detail, and as possibly best seen in FIGS. 9 and 10, a spacer 44 is connected to the headrail 30 and bridges a space between adjacent ends of the linkage system 38M associated with the mobile vanes and the linkage system 38S associated with the stationary vanes 22S. The spacer is provided to maintain a desired relationship between a fixed end 46 of the set of mobile vanes and a distal end 48 of the set of stationary vanes as will be appreciated with the following description. A movable end 50 of the set of mobile vanes is adapted to be extended or retracted reversibly across the architectural opening between extended and retracted positions. The proximal end 52 of the set of stationary vanes is fixed adjacent to the aforenoted one end 32 of the headrail.

The independent linkage systems 38M and 38S for the mobile and stationary vanes, respectively, as well as the carriers 40 for suspending the vanes 22M and 22S in the preferred embodiment are identical to the corresponding elements disclosed in U.S. Pat. No. 5,626,177, which is hereby incorporated by reference. The control system itself of the present invention, which includes the independent linkage systems and the carriers, further includes a control cord 54 (FIGS. 9-15) for manipulating the carriers associated with the mobile vanes 22M. The carriers associated with the mobile vanes are slidably movable along the length of the headrail 30 so as to move the covering 20 between the extended position of FIG. 1 and the retracted position of FIG. 2. Each individual carrier in the linkage system for at least the mobile vanes includes a system for pivotally moving its associated vane between the open and closed positions mentioned previously. As implied from the description previously, the control system for the mobile vanes can be adapted to move all of the mobile vanes from an extended position across an architectural opening to a retracted position adjacent one side of the opening in a side-draw covering or adjacent complementary control systems associated with left and right panels LP and RP can be utilized individually or in combination in a center-draw covering as illustrated so that the mobile vanes in one panel LP are retracted toward one side of the opening while the mobile vanes in the other panel RP are retracted toward the opposite side.

The headrail 30 is mounted on a support surface (not shown) with conventional brackets (not shown). The headrail (FIG. 15) is a channel-shaped extruded member with an upwardly opening longitudinal passage 56. The carriers 40 are slidably movable along the headrail. End caps 58 are also provided at opposite ends of the headrail for aesthetics and to facilitate mounting and operation of the control system.

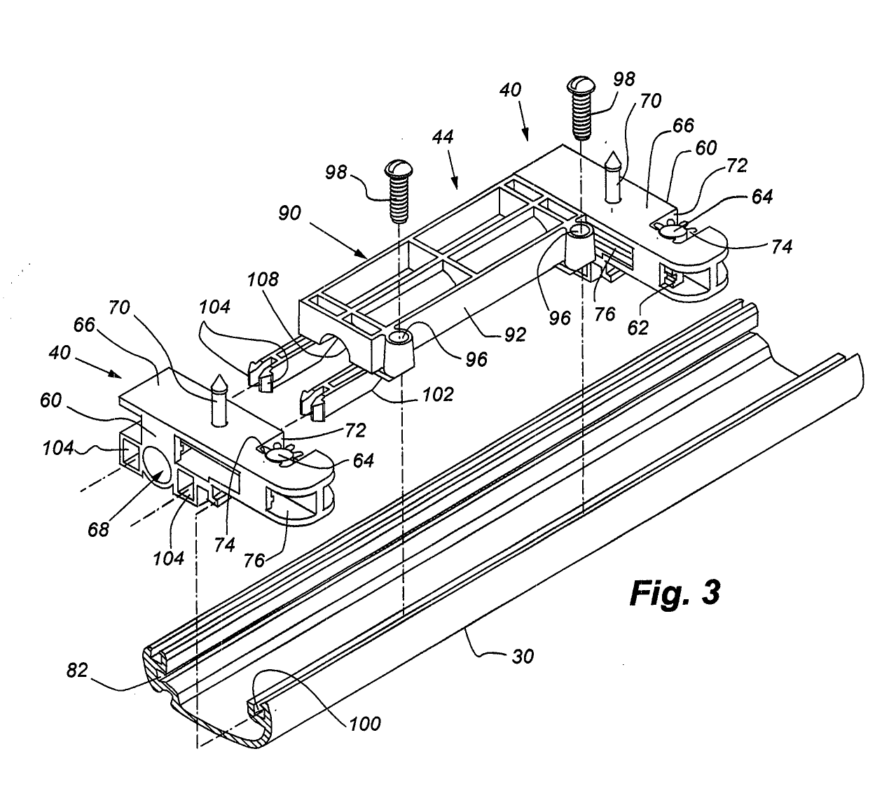

Each carrier 40, as best seen in FIG. 3, associated with a mobile vane 22M is configured to include a carrier body 60, a rack 62 and a hanger pin 64. The rack may optionally be removed or eliminated from the carriers associated with the stationary vanes 22S as will become clearer hereafter. The carrier body is preferably an injection-molded component and made from a low-friction plastic material having a relatively flat top wall 66 underneath which are formed a number of passages or notches between various walls or partitions. At one end of the body adjacent a lower portion thereof is a transverse passage 68 of substantially cylindrical configuration. The passage is slightly larger in diameter than the tilt rod 42 and is adapted to slidably and rotatably receive the tilt rod.

The top wall 66 has a centrally located upstanding cylindrical pin 70 with an enlarged frustoconical head adapted to connect the carrier body to an overlying linkage 38M or 38S (FIGS. 9-14).

A hanger pin 64 for interconnecting a carrier 40 to an associated vane 22M or 22S is releasably connected to the carrier body 60 in a recess 72 at the opposite end of the carrier from the transverse passage 68 so the hanger pin can pivot in the carrier body about a vertical axis. The hanger pin has a horizontally disposed pinion gear 74 to effect rotation of the hanger pin as will be explained hereafter.

The vertical axis of the hanger pin 64 is slightly offset from a horizontally-extending, longitudinal channel 76 defined through the carrier body 60 by a plurality of wall members. The channel is probably best seen in FIG. 3. The teeth on the pinion gear 74 of the hanger pin protrude into the horizontal channel. The channel can slidably receives a rack 62. One end of the rack is positioned adjacent to the pinion gear. The one end of the rack has a set of teeth (not seen) on a side wall thereof which mesh with the teeth on the pinion gear. The opposite end of the rack has a second set of teeth (not seen) formed along the lower surface thereof.

The channel 76 through the carrier body that receives the rack 62 also communicates with the substantially cylindrical transverse passage 68 in the carrier body that receives the tilt rod 42. The second set of teeth on the rack protrude into the transverse passage and mesh with longitudinally-extending circumferentially spaced teeth 78 on the tilt rod. It will, therefore, be appreciated that rotation of the tilt rod causes the rack to be translated or moved linearly and longitudinally of the carrier body and as a consequence, the first set of teeth on the rack, which are engaged with the pinion gear 74 on the hanger pin 64, pivot the hanger pin in a direction dependent upon the direction of linear movement of the rack.

As mentioned previously, the carriers 40 are interconnected to the other carriers associated with either the mobile set of vanes 22M or the stationary set of vanes 22S and to the end caps 58 of the headrail 30 by one of the linkage systems 38M or 38S, which are in the form of a pantograph otherwise known as a scissors-type linkage. The scissors-type linkage is, therefore, adapted to be extended (FIG. 14) to a maximum length which is predetermined by a predetermined number of interconnected links 80 in a set or retracted into a compact position as seen in FIG. 12 wherein corresponding links on adjacent pairs of links are positioned contiguous with each other.

The scissors-type linkage systems 38M and 38S are interconnected with associated carriers 40 in the system through the upstanding pin 70 on the top wall 66 of the carriers. This pin is made of a somewhat resilient material so it can be forced through an opening in a pivoted joint intermediate the ends of two links in a pair of links of the scissors-type linkage system (FIGS. 9-14). Each pair of links is thereby associated with an individual carrier and pivotally confined between the head on the pin 70 and the top wall 66 of the carrier body. It will, therefore, be appreciated that extension or retraction of the scissors-type linkage causes the connected carriers in an associated system to move accordingly so that the carriers are movable between a fully-extended, equally-spaced position, as shown in FIG. 10, and a closely adjacent retracted or horizontally stacked relationship, as shown in FIG. 12. This, of course, is only true of the carriers associated with the mobile vanes 22M, as it is only the scissors-type linkage associated with the mobile vanes that is actually extended or retracted as will be described in more detail later. The scissors-type linkage associated with the stationary vanes 22S is designed to remain in a fixed position.

The carriers 40 are confined in their movement through their interrelationship with the headrail 30, as is probably best appreciated by reference to FIG. 15. Each carrier is designed to receive a track element 82 in the headrail, which confines the sliding movement of the carrier along the headrail.

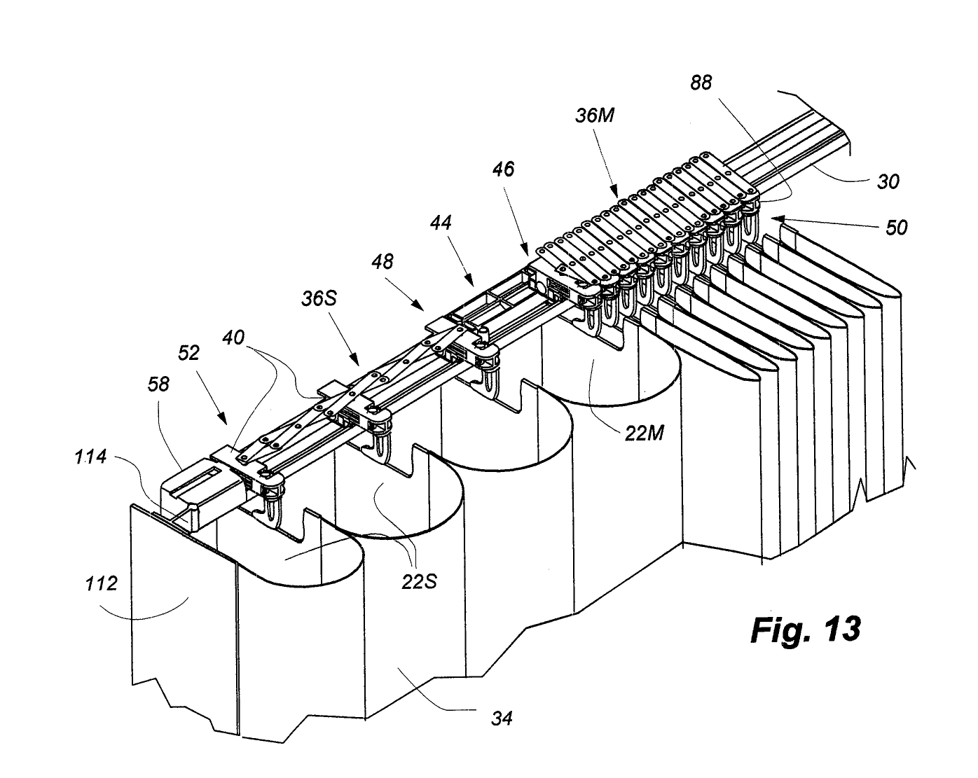

The linkage system 38M associated with the mobile vanes 22M is extended and retracted with the control cord 54. The control cord has a first end that enters the headrail from the first or primary end 32 thereof and is extended longitudinally of the headrail beneath the carriers associated with the stationary vanes 22S and the carriers associated with the mobile vanes 22M until the cord reaches the opposite or secondary end 86 of the headrail. At the second end of the headrail, the control cord passes around a pulley (not shown) and is thereafter extended longitudinally of the headrail toward the first end of the headrail. The first end of the control cord is then anchored to the lead carrier 88 (FIGS. 12 and 13), i.e. the carrier in the mobile set of carriers at the movable end thereof which travels the greatest distance in moving the mobile vanes between extended and retracted positions. The second or opposite end of the control cord is also fed into the headrail through the first or primary end 32 and is extended through the carriers 40, both stationary and mobile, until it reaches the lead carrier 88 so that it too can be connected to the lead carrier. This, of course, establishes a loop of the control cord with an end (not shown) of the loop adjacent the primary end of the headrail hanging downwardly therefrom for access by a user. The loop can thereby be circulated in one direction or another, so the lead carrier can be shifted toward or away from the opposite end 86 of the headrail and in doing so extend or retract the scissors-type linkage system 38M associated with the mobile vanes and thus the carriers supporting the mobile vanes. Movement of the stationary vanes is unaffected as will be described hereafter.

When there are dual panels LP and RP as in the center-draw covering shown in FIGS. 1 and 2, a separate system as described above could be provided for each panel or both panels could be moved simultaneously through a combination of two such systems for operation from one end of the headrail as would be evident to one skilled in the art.

A second control system (not shown) for rotating the tilt rod 42 about its longitudinal axis can be incorporated into the system in any suitable manner which is well known to those in the art so that the tilt rod can be selectively rotated in one direction or the other to pivot the mobile vanes 22M and optionally the stationary vanes about their longitudinal vertical axes as discussed previously.

The rack 62, previously described as being a component of the carriers 40 associated with the mobile vanes 22M and optionally the stationary vanes 22S, is the operative element that allows the tilt rod 42 to pivot the vanes about their longitudinal axes. As mentioned previously, the teeth at one end of the rack engage the tilt rod so that as the tilt rod is rotated the rack is translated along the longitudinal dimension of a carrier. As the rack is being translated, the other set of teeth on the rack pivot the hanger pin 64, which in turn pivots the vane 22M or 22S associated therewith. It will be evident from the above that by eliminating the rack from a carrier, the rotation of the tilt rod would not effect pivoting of the associated vane and, accordingly, the carriers associated with the stationary vanes 22S may not include a rack if it were desired that they not pivot as illustrated in solid lines in the drawings. In addition, the vanes 22S could be fixed in position relative to their carriers with adhesive or some other form of bonding, if desired, to make sure the stationary vanes do not move due to air currents, or contact from an individual adjacent to the covering.

The stationary vanes 22S are prevented from being translated along the headrail 30 by providing a separate linkage system 38S for the stationary vanes 22S from the linkage system 38M associated with the mobile vanes 22M. In this manner, the mobile vanes can be translated along the length of the headrail in moving the covering between extended and retracted positions while not affecting the stationary vanes thereby permitting them to remain in a fixed uniformly spaced relationship.

With reference to FIGS. 9 and 10, the spacer 44 is seen connected to the headrail 30 in a fixed position and as will be described hereafter, the spacer is used to anchor adjacent ends of the linkage system 38M associated with the mobile vanes and the linkage system 38S associated with the stationary vanes. The opposite end of the linkage 38S associated with the stationary vanes is merely connected to the carrier 40 associated with the last vane adjacent to the primary end 32 of the headrail. The linkage associated with the stationary system is also fixed in its fully-extended position so as to hold all of the carriers associated with stationary vanes in a fixed, uniformly spaced and extended position relative to the longitudinal axis of the headrail at all times. In the present disclosure, there are only three stationary vanes 22S, but any number could be provided.

The linkage system 38M associated with the mobile vanes 22M, as mentioned, has one end, its fixed end 46, anchored to the spacer 44 and its opposite or movable end 50 to the lead carrier 88, so that this linkage system can be extended and retracted by circulating movement of the control cord 54, as mentioned previously.

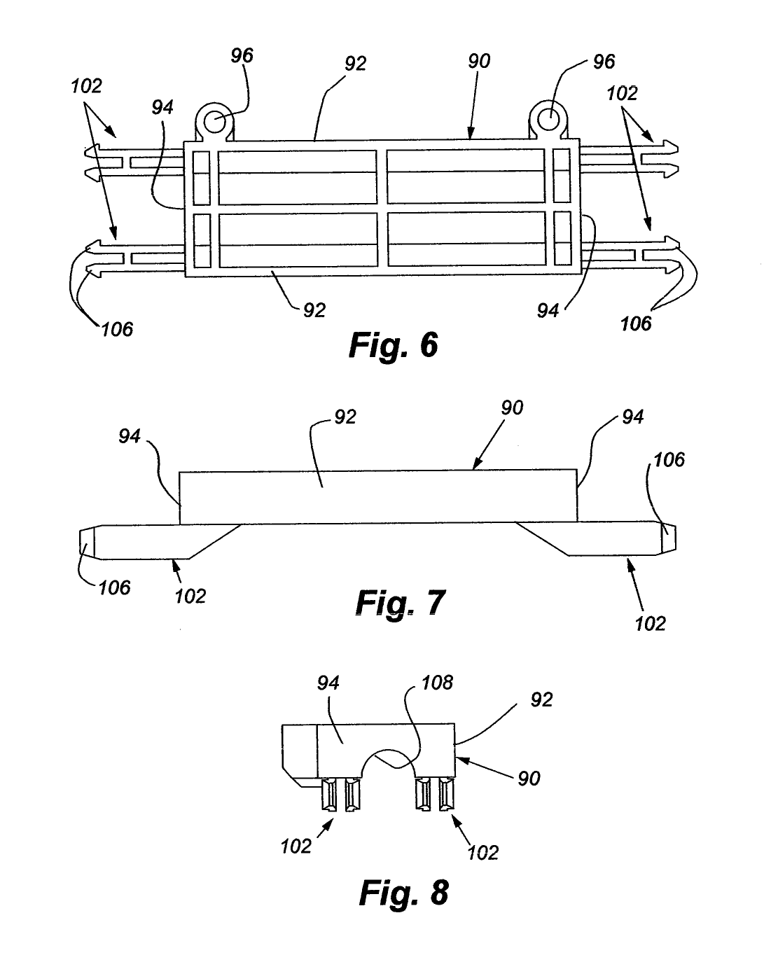

The spacer 44 itself is shown in detail in FIGS. 3-8, and it will be seen to include a generally rectangular body 90 having elongated side walls 92 and end walls 94 that are perpendicular to the side walls at opposite ends thereof. A pair of vertical cylindrical passages 96 are provided in the main body at opposite ends so that threaded fasteners 98 can be extended through the passages and into an extruded groove 100 in the headrail 30 to positively position the spacer at a desired location along the length of the headrail. The spacer also includes two pairs of longitudinally-extending connecting legs 102 at each end thereof which are adapted to be received in rectangular passages 104 through an associated carrier 40, and each of the legs has enlarged heads 106 and is made of a somewhat resilient material so that once a carrier is fully inserted onto associated legs of the spacer, the enlarged heads will snap into place to hold the carrier in closely adjacent contiguous relationship with the ends of the spacer. The spacer includes a semi-cylindrical, longitudinally-extending channel 108 that opens downwardly and rotatably receives the tilt rod 42 so that the tilt rod can extend uninterruptedly from one end of the headrail 30 to the other. It will also be appreciated by reference to FIG. 15 that a space 110 is defined between the spacer and the bottom wall of the headrail through which each run of the control cord 54 can pass as it extends past the spacer.

The spacer 44 is of a predetermined length to establish a desired spacing between the distal stationary vane 22S and the fixed mobile vane 22M that are adjacent to each other with this spacing also correlating with the spacing between any other adjacent vanes when the linkage system associated with those vanes is fully extended. In this manner, when the covering is fully extended, as shown in FIG. 1, there is no disruption in the appearance of the covering at the juncture between the set of stationary vanes 22S and the set of mobile vanes 22M. By reference to FIG. 2, it will also be seen that the loop of face sheet material 34 between the set of stationary vanes and the set of mobile vanes correlates with the loops of fabric between adjacent stationary vanes so that there are four loops that are desirably formed to correlate with each other even when the mobile vanes have been moved into the retracted or horizontally stacked position of the retracted covering.

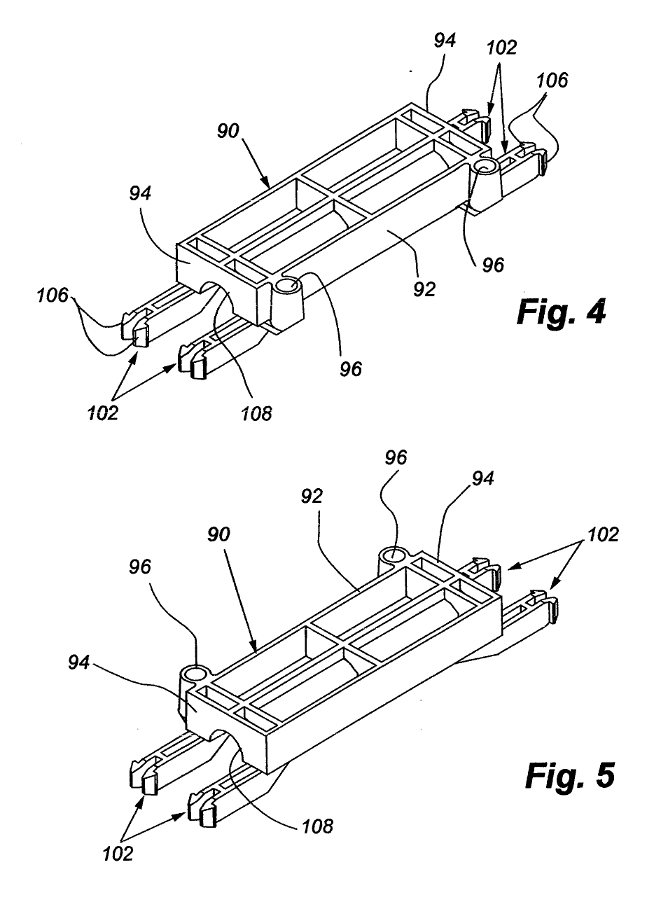

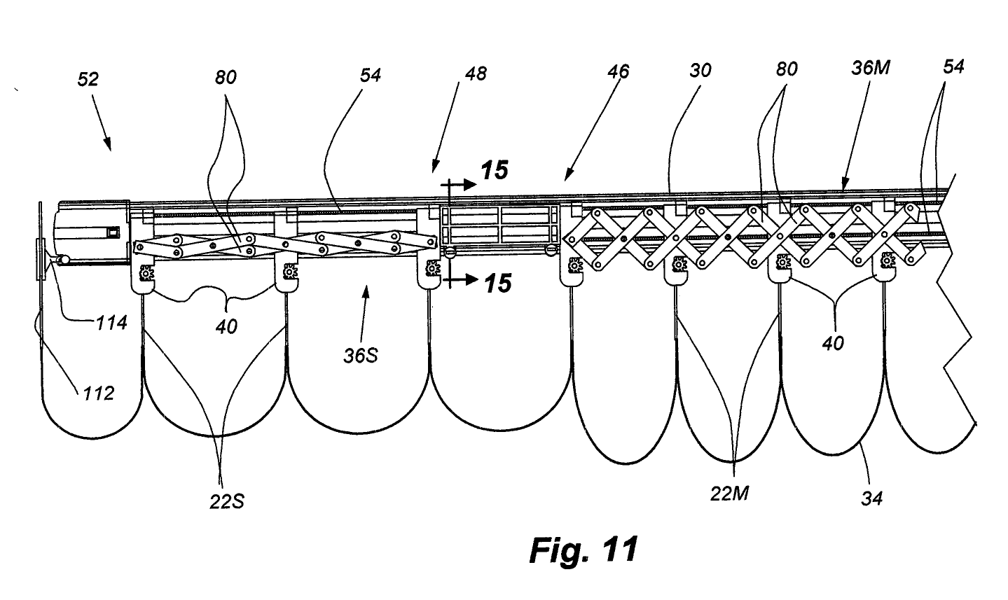

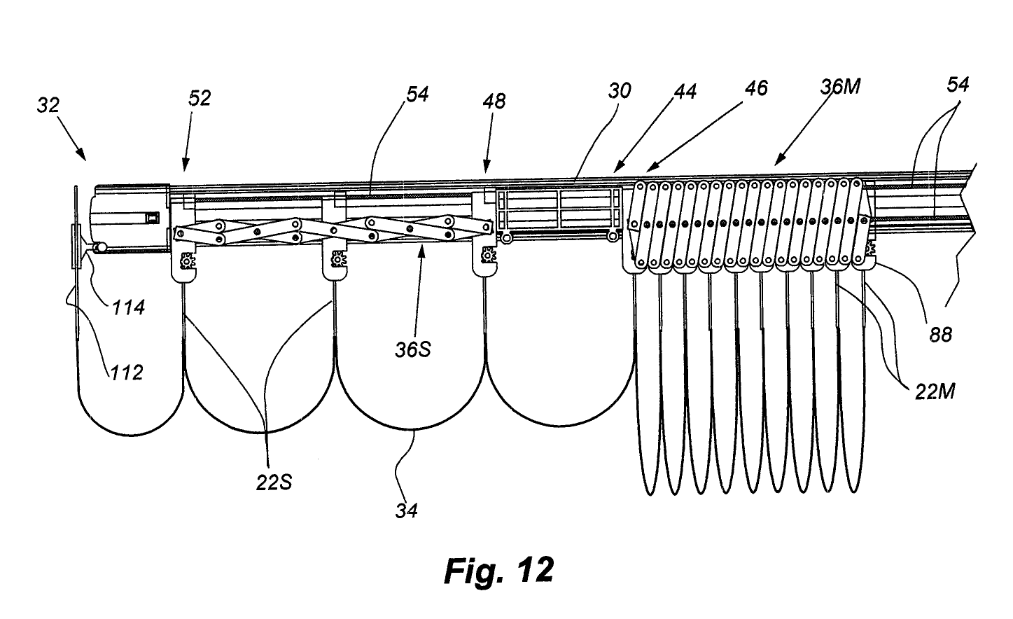

FIGS. 9 and 10 illustrate the fully-extended position of the linkage associated with both the stationary 22S and mobile 22M vanes when the covering is fully extended and the uniformity of the looped face sheet material 34 in this fully-extended position. FIG. 11 shows the mobile vanes being moved to an intermediate position between fully extended and fully retracted, and FIGS. 12 and 13 show the mobile vanes fully retracted but in an open position or parallel with the stationary vanes. FIG. 14 shows the mobile vanes pivoted into their closed position and the stationary vanes in a solid line representation in an open position while the covering is fully extended. FIG. 14 also shows a dashed-line representation of the stationary vanes in a closed position. As mentioned previously, if the racks 62 used in the carriers associated with the movable vanes are also retained in the carriers associated with the stationary vanes, the stationary vanes will pivot with the movable vanes (as illustrated in dashed lines in FIG. 14) between open and closed positions. If the racks 62 are removed from the carriers associated with the stationary vanes, they will not pivot with the movable vanes but will remain stationary in an open position as shown in solid lines in FIG. 4 if that is how they are initially positioned.

It should also be appreciated that end vanes 112 are provided adjacent opposite ends of the headrail 30 with a pivotal link arm 114 so as to desirably cover the end of the headrail in a known manner.

A covering 20 made in accordance with the present invention could be mounted in a building structure adjacent to an architectural opening in any manner, but it finds a primary purpose in overlapping the set of stationary vanes 22S with a wall adjacent to the architectural opening while the set of mobile vanes 22M cover the opening itself.

It will be appreciated from the above that a covering for architectural openings can be made with a center draw or a side draw in a manner so that it can be mounted on a support structure in which an architectural opening is provided so that only a mobile and movable part of the covering extends across the architectural opening, while a stationary portion extends across an adjacent wall. It should also be appreciated that while one control system has been described, other systems for achieving the same operational results could be utilized without distracting from the primary feature of the invention of providing stationary as well as mobile vanes in a common covering.

Although the present invention has been described with a certain degree of particularity, it is understood the disclosure has been made by way of example, and changes in detail or structure may be made without departing from the spirit of the invention as defined in the appended claims.

What is claimed is:

1. A vertical vane covering for an architectural opening comprising in combination:
a horizontally extending headrail,
stationary and mobile sets of vertically extending vanes suspended from said headrail, and
a control system for operating said covering to translate the mobile vanes as a set along the length of the headrail between extended and retracted positions and independently of said translation pivot said mobile vanes as a set about vertical longitudinal axes between open and closed positions while simultaneously permitting said stationary vanes to remain immobile whether or not the mobile vanes are being translated or rotated.

2. The covering of claim 1 wherein said set of mobile vanes has a fixed end and a movable end, said movable end being movable toward and away from said fixed end as said mobile vanes retract and extend respectively.

3. The covering of claim 2 wherein said stationary set of vanes extend from one end of said headrail to an adjacent relationship with said fixed end of said set of mobile vanes whereby said fixed end of said set of mobile vanes is spaced from said one end of said headrail.

4. The covering of claim 3 wherein said control system includes a flexible cord extending between opposite ends of said headrail and being movable from said one end of said headrail, said cord being operatively connected to said movable end of said set of mobile vanes to move said movable end in unison with movement of said cord to extend and retract said mobile set of vanes, said flexible cord slidably passing by said set of stationary vanes to have no effect on said stationary set of vanes even when said cord is being moved.

5. The covering of claim 3 or 4 wherein said control system includes an elongated tilt rod extending between opposite ends of said headrail, said tilt rod being rotatable from said one end of said headrail about its longitudinal axis and being operatively connected to said mobile vanes to simultaneously pivot said vanes between open and closed positions upon rotation of said tilt rod, said tilt rod having no operative relationship with said stationary vanes whereby said stationary vanes remain fixed in position even upon rotation of said tilt rod.

6. The covering of claim 5 wherein said control system includes a stationary linkage interconnecting said vanes of the stationary set and a mobile linkage interconnecting said vanes of the mobile set, whereby said stationary set of vanes remain in a stationary desirably spaced relationship and said mobile vanes are movable together as a set.

7. The covering of claim 6 wherein said mobile linkage is a scissors-type linkage.

8. The covering of claim 7 wherein said stationary linkage is a scissors-type linkage.

9. The covering of claim 6 wherein said control system further includes a spacer interconnecting the adjacent ends of said stationary set of vanes and said mobile set of vanes to retain a fixed spacing between the stationary set of vanes and the mobile set of vanes.

10. The covering of claim 9 wherein both the stationary linkage and the mobile linkage are secured to said spacer.

11. The covering of claim 3 further including a front sheet of fabric material interconnecting adjacent vanes in the covering.
